(19) United States
(12) Patent Application Publication
(10) Pub. No.: US 2023/0016239 A1
(43) Pub. Date: Jan. 19, 2023

(54) METHODS FOR HYDROPHOBIZING ARROWS OF A BOW-AND-ARROW SYSTEM

(71) Applicant: WIFLER INDUSTRIES LLC, Crete, IL (US)

(72) Inventor: Alex WIFLER, Crete, IL (US)

(21) Appl. No.: 17/378,132

(22) Filed: Jul. 16, 2021

(51) Int. Cl. F42B 6/04; F41B 5/14

(52) U.S. Cl. CPC F42B 6/04; F41B 5/1411; C09D 5/1681

(57) ABSTRACT

Methods for hydrophobizing arrows are described herein. In one aspect, the method can include applying a ceramic-based hydrophobic coating to the arrow; and curing the arrow for a predefined period of time.

### BACKGROUND OF THE INVENTION

Arrow for bows can be composed of water-absorbing materials. For example, conventional competition arrows can be composed of high modulus carbon fiber, aluminum-carbon composite, and the like. However, these compositions are naturally water-absorbent. For example, the surface of the arrows may be porous, such that when exposed to water, the arrow retains some of the water within the pores, causing the arrows to be waterlogged. When waterlogged, the characteristics of the arrow can be altered. For example, the weight of the arrow increases with water absorption, which can affect the projected flight path of the arrow when shot from a bowstring, particularly when compared to dry arrows.

To date, there are no known techniques for hydrophobizing arrows for a bow-and-arrow system.

### SUMMARY

Methods for hydrophobizing arrows are described herein. In one aspect, the method can include applying a ceramic-based hydrophobic coating to the arrow; and curing the arrow for a predefined period of time.

This aspect can include a variety of embodiments. In one embodiment, applying the ceramic-based hydrophobic coating further includes spraying the ceramic-based hydrophobic coating onto the arrow.

In another embodiment, the ceramic-based hydrophobic coating is composed of silicon dioxide, titanium dioxide, or a combination thereof.

In another embodiment, the predefined period of time can be 24 hours.

In another embodiment, the bowstring is composed of a high modulus carbon fiber, an aluminum-carbon composite, or a combination thereof.

In another embodiment, the ceramic-based hydrophobic coating can be a car coating liquid.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts an image of weighing a dry carbon arrow.

FIG. 2 depicts an image of submerging a carbon arrow into a volume of water.

FIG. 3 depicts an image of weighing a waterlogged arrow.

FIG. 4 depicts an image of a volume of ceramic-based hydrophobic coating according to an embodiment of the present disclosure.

FIG. 5 depicts an image of a user wetting a cloth with the ceramic-based hydrophobic coating for applying to an arrow according to an embodiment of the present disclosure.

FIG. 6 depicts an image of an arrow coated with the ceramic-based hydrophobic coating submerged in water.

FIG. 7 depicts an image of weighing an arrow coated with the ceramic-based hydrophobic coating.

FIG. 8 depicts a process flow for hydrophobizing an arrow according to an embodiment of the present disclosure.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Methods for hydrophobizing arrows of a bow-and-arrow system are described herein. The method can include applying a hydrophobizing coating to the arrow. The hydrophobizing coating can be a car coating liquid that is ceramic-based. The coating can bond with the composition of the arrow after a curing period, which can hydrophobize the arrow.

The hydrophobic coating can be composed of a ceramic-based composition. In some cases, the coating can include silicon dioxide, titanium dioxide, or a combination thereof. In some cases, the hydrophobic coating can be a car coating. Examples of ceramic-based car coatings can be those coatings sold by Modesta, Nanolex, CQuartz, Ceramic Pro and IGL Kenzo.

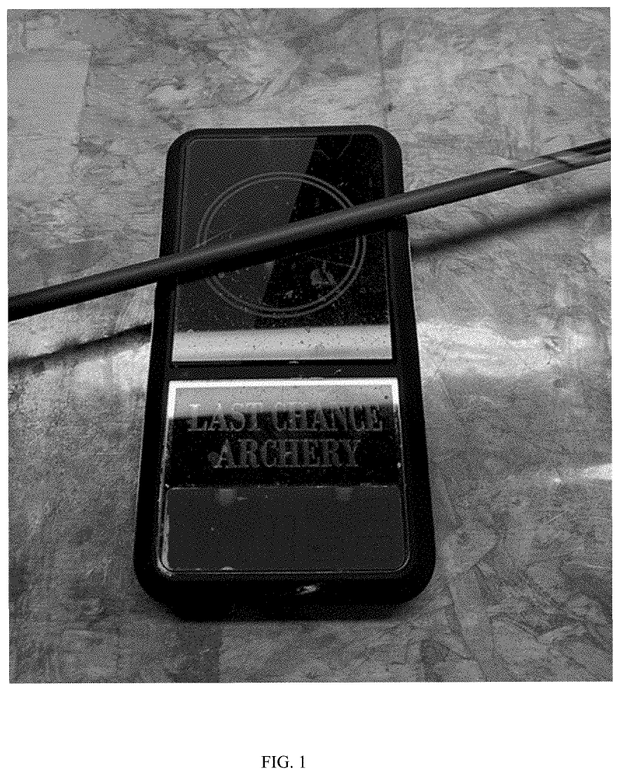

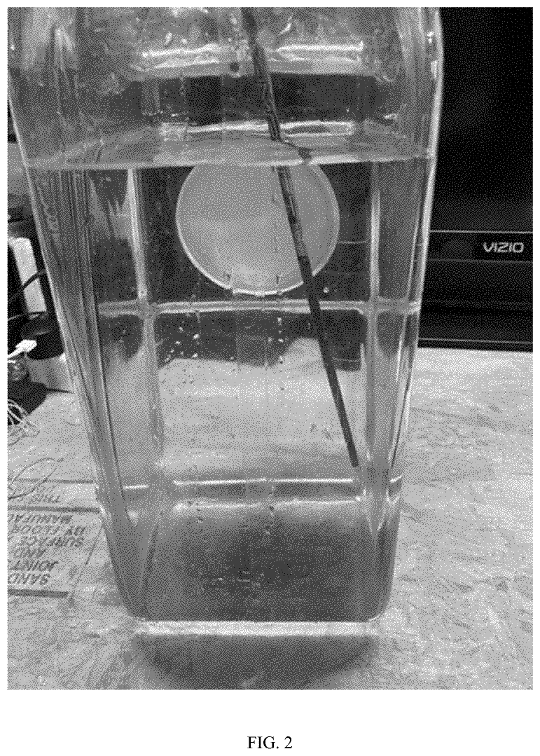

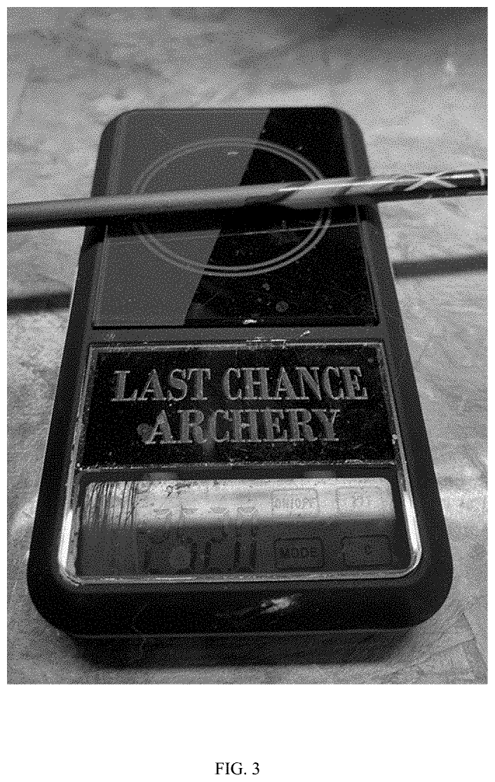

FIG. 1 depicts a dry arrow of a bow-and-arrow system. The arrow can be dry and uncoated. The arrow can be composed of a carbon-based material. However, the surface of the arrow may be porous. When exposed to water (e.g., as shown in FIG. 2), some of the water can be trapped within the pores. Thus, the arrow can become waterlogged. This can affect the weight of the arrow (e.g., shown in FIG. 3), which can alter the flight mechanics of the arrow compared to that of a dry arrow. For example, the weight between the arrow in a dry state (as depicted in FIG. 1) compared to the arrow in a waterlogged state (as depicted in FIG. 3) can differ by several grains.

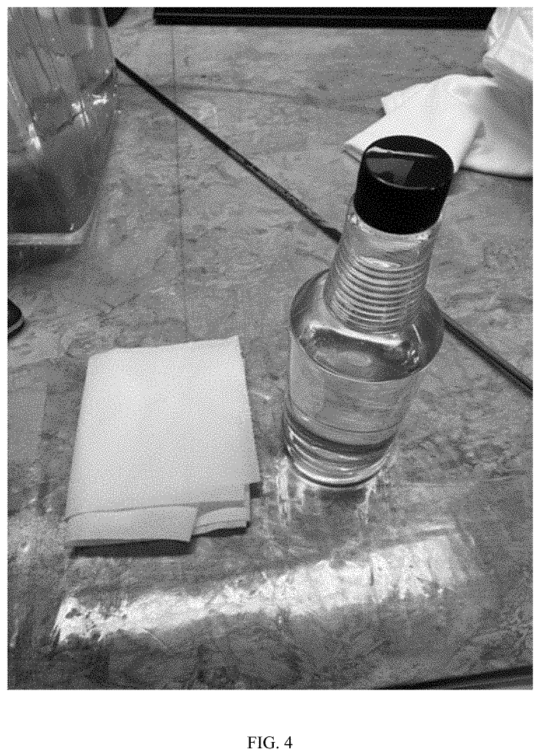

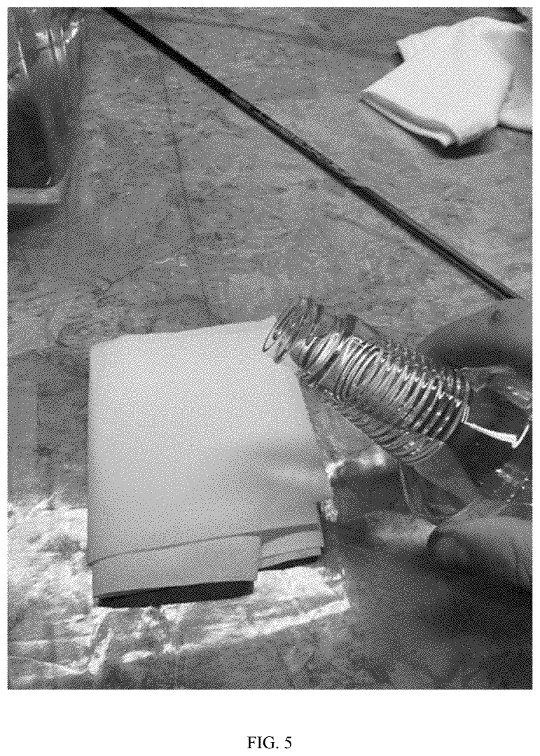

FIG. 4 depicts an image of the ceramic-based hydrophobic coating according to an embodiment of the present disclosure. The coating can be in liquid form, and in some cases can be wiped onto the surface of the arrow. In some cases, the coating can be sprayed onto the instead. The image of FIG. 5 depicts a user placing the coating onto a cloth for application onto an arrow. In some cases, the arrow can be supported (e.g., via vise, support stands, and the like) for ease of the coating application. In some cases, the arrow can be positioned in a horizontal fashion, or in a vertical fashion, for applying the coating. In some cases, the coating can be sprayed a sufficient number of times to cover the surface of the arrow, for example, 10 pumps of the spray. In some cases, the coating can be wiped along the length of the arrow (e.g., with a towel or a user's finger). In some cases, the spray can be a distance away from the arrow for sufficient coverage of the arrow when sprayed (e.g., 6 inches away, 12 inches away, and the like). Further, the coating can be applied across the entire surface of the arrow for sufficient coverage.

The coated arrow can be left to cure for a curing period. After a curing period subsequent to the application of the coating, the coating can form a semi-permanent bond with the arrow surface. In some cases, the curing period can be a sufficient amount of time for the coating to cover the surface of the arrow (e.g., 5 seconds, 10 seconds, 30 seconds, 1 minute, and the like). In other cases, the curing time can be a sufficient amount of time for the coating to dry on the surface of the arrow (e.g., 1 minute, 1 hour, 24 hours, and the like). In some cases, the arrow can be isolated from contacting surfaces during the curing time, so as to not smear or remove the coating from the surface of the arrow.

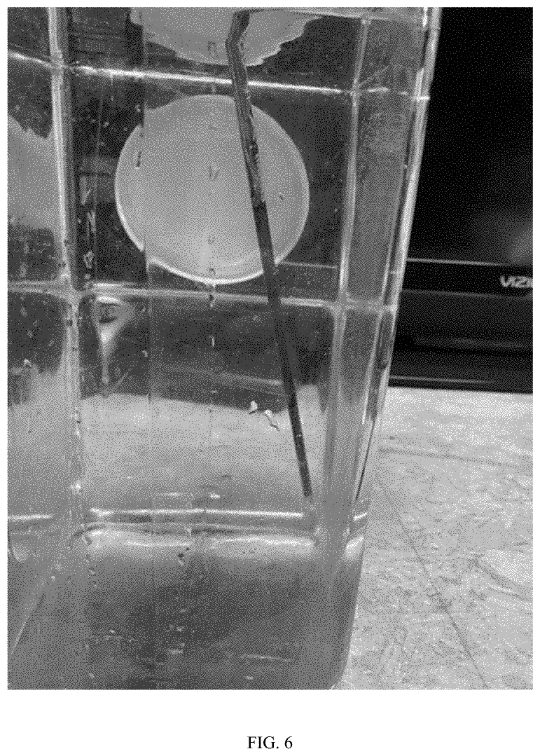

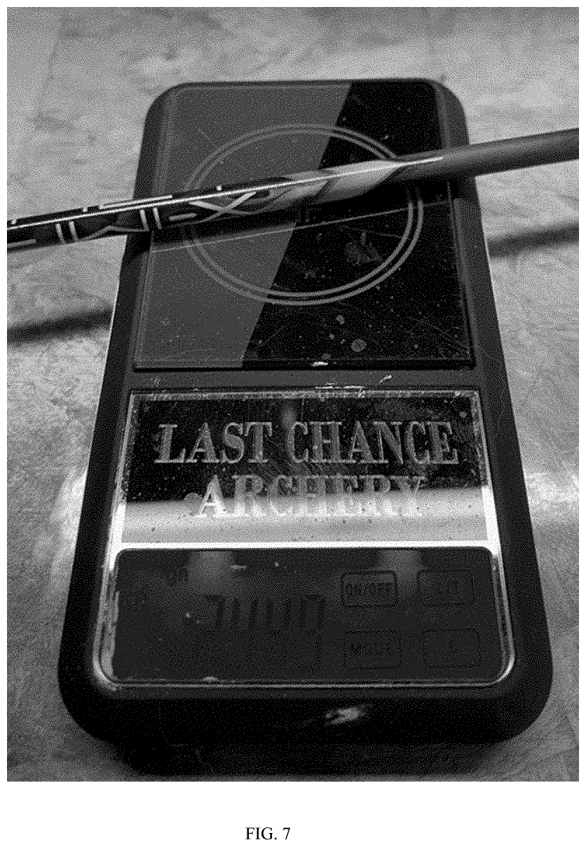

FIG. 6 depicts an image of a coated arrow being submerged in water. The coated arrow is then removed from and weighed, similar to the process depicted in FIGS. 2 and 3 for an uncoated arrow. As can be seen in the weight measurements between the coated arrow (FIG. 7) and the uncoated arrow (FIG. 3) after water submersion, the water does not absorb into the coated arrow, and instead wicks off the arrow surface.

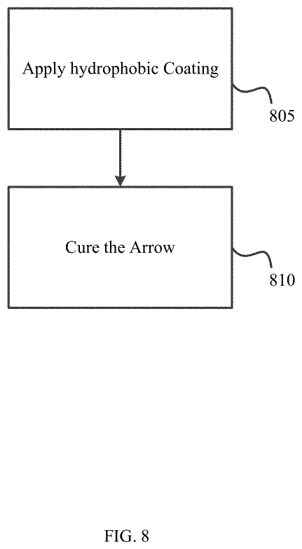

FIG. 8 depicts a process flow for hydrophobizing a bowstring, according to an embodiment of the present disclosure.

At Step 805, a ceramic-based hydrophobic coating can be applied to the arrow. In some cases, the arrow can be composed of high modulus carbon fiber, aluminum-carbon composite, of a combination thereof. In some cases, the ceramic-based hydrophobic coating can be composed of silicon dioxide, titanium dioxide, or a combination thereof. In some cases, ceramic-based hydrophobic coating can be in spray form. In some cases, the ceramic-based hydrophobic coating can be a car coating spray.

At Step 410, the arrow can be cured for a predefined period of time. In some cases, the predefined period of time can be 10 seconds. In some cases, the predefined period of time can be 1 minute. In some cases, the predefined period of time can be 24 hours.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A method for hydrophobizing an arrow of a bow-and-arrow system comprising:
applying a ceramic-based hydrophobic coating to the arrow; and
curing the arrow for a predefined period of time.

2. The method of claim 1, wherein applying the ceramic-based hydrophobic coating further comprises spraying the ceramic-based hydrophobic coating onto the arrow.

3. The method of claim 1, wherein the ceramic-based hydrophobic coating comprises silicone dioxide, titanium dioxide, or a combination thereof.

4. The method of claim 1, wherein the predefined period of time comprises 24 hours.

5. The method of claim 1, wherein the bowstring is composed of a high modulus carbon fiber, aluminum-carbon composite, or a combination thereof.

6. The method of claim 1, wherein the ceramic-based hydrophobic coating comprises a car coating liquid.
